(19) United States
(12) Patent Application Publication
(10) Pub. No.: US 2026/0171690 A1
(43) Pub. Date: Jun. 18, 2026

(54) CONDUCTOR ASSEMBLY

(71) Applicant: CUMMINS INC., Columbus, IN (US)

(72) Inventors: Gabriel Vincent Tenaglia, Columbus, IN (US); Santhosh Krishnamoorthi, Indianapolis, IN (US); Joseph William Giannini, Oakdale, MN (US); Jaroslaw Leonarski, Columbus, IN (US); Dakshina Murthy Bellur, Plymouth, MN (US)

(73) Assignee: CUMMINS INC., Columbus, IN (US)

(21) Appl. No.: 18/985,981

(22) Filed: Dec. 18, 2024

(51) Int. Cl. H01R 9/22; H01R 9/18

(52) U.S. Cl. CPC H01R 9/223; H01R 9/18

(57) ABSTRACT

A conductor assembly includes a first spacer, a second spacer, a plurality of bus bars positioned between the first spacer and the second spacer, and a plurality of fasteners coupling the first spacer and the second spacer. The first spacer is shaped to receive the plurality of bus bars.

### STATEMENT REGARDING FEDERALLY SPONSORED RESEARCH OR DEVELOPMENT

This invention was made with Government support under DE-EE0009652 awarded by the Department of Energy (DOE). The Government has certain rights in this invention.

### FIELD

The present invention relates generally to the field of electrical conductor assemblies.

### BACKGROUND

Spacers are commonly used in various electrical, mechanical, and electronic systems to maintain a distance between components and provide structural support. In electrical assemblies, spacers are often used to separate conductive components such as bus bars, wires, or other electrical conductors to prevent short circuits, manage creepage and clearance distances, and improve insulation between components.

### SUMMARY

One embodiment relates to a conductor assembly. The conductor assembly includes a first spacer, a second spacer, a plurality of bus bars positioned between the first spacer and the second spacer, and a plurality of fasteners coupling the first spacer and the second spacer. The plurality of bus bars include at least one curve or bend therein. The first spacer is shaped to receive the plurality of bus bars.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims.

FIG. 1 is a view of a of a conductor assembly, according to an example embodiment.

FIG. 2 is an exploded view of the conductor assembly of FIG. 1.

FIG. 3 is a bottom view of the conductor assembly of FIG. 1.

### DETAILED DESCRIPTION

Following below are more detailed descriptions of various concepts related to, and implementations of a conductor assembly. The systems introduced herein may be implemented in various ways, as the described concepts are not limited to any particular manner of implementation. Examples of specific implementations and applications are provided primarily for illustrative purposes.

Before turning to the figures, various embodiments of the conductor assembly and the components thereof, such as bus bars, are described herein. It should be understood that, while individual components are described in detail, the details should be considered as examples only. Further, the details may include variations described herein. Accordingly, it should be understood that, although individual components may be described relative to an embodiment, any of the components may be used in any other embodiment described herein, unless otherwise noted.

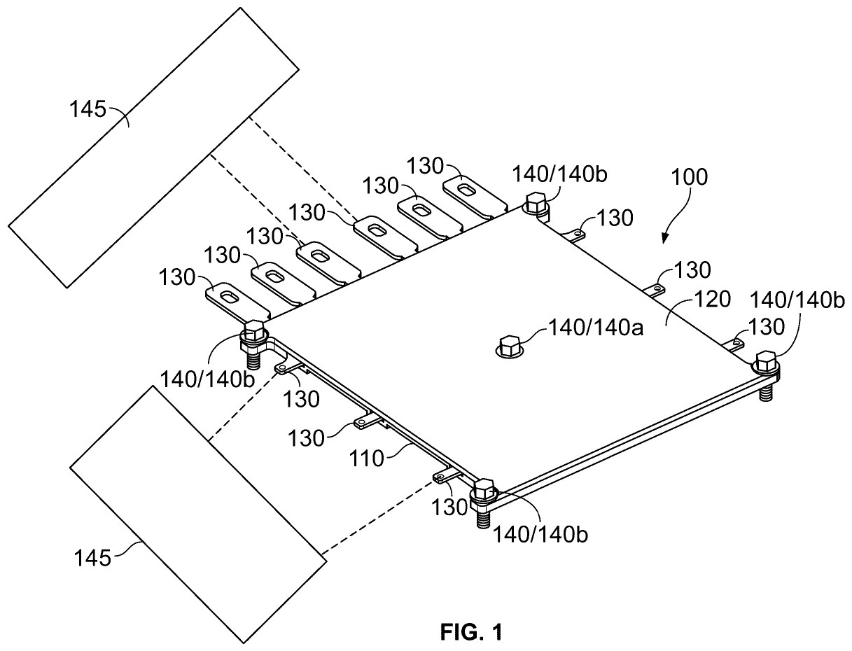

Embodiments described herein relate generally to a conductor assembly and components thereof. FIG. 1 depicts a conductor assembly 100. The conductor assembly 100 may be referred to as conductor spacer or conductor spacer assembly. The conductor assembly 100 can be or include a structural framework configured to position and secure conductive components. Various embodiments of the conductor assembly 100 provide electrical insulation, mechanical stability, and thermal management, ensuring proper alignment and spacing of the conductive components to reduce the risk of electrical arcing and to facilitate heat dissipation.

As shown in FIGS. 1-3, the conductor assembly 100 comprises a first spacer 110 and a second spacer 120. A plurality of bus bars 130 are positioned between the first spacer 110 and the second spacer 120. The plurality of bus bars 130 include at least one curve or bend therein. The first spacer 110 is shaped to receive the plurality of bus bars 130. A plurality of fasteners 140 couple the first spacer 110 and the second spacer 120. As identified in FIG. 1, the plurality of fasteners 140 may take the form of one or more central fasteners 140a and one or more peripheral fasteners 140b.

The conductor assembly 100 is configured to connect to electrical components 145. For example, the conductor assembly 100 may connect to electrical components 145 that are power distribution components (e.g., transformers, circuit breakers, or switchgear), which regulate and control the flow of electricity within an electrical device. The conductor assembly 100 may interface with electrical components 145 that are energy storage systems (e.g., batteries or capacitors). In some applications, the electrical components 145 can include electric motors, generators, power inverters, and/or rectifiers.

In various embodiments described herein, the conductor assembly 100 may include more or fewer components. For example, the conductor assembly 100 may include one or more components defining a mounting or support structure to further secure the bus bars 130 or enhance heat dissipation properties.

The first spacer 110 can be configured to provide a supportive structure for holding the bus bars 130 in a defined position within the conductor assembly 100. In some embodiments, the first spacer 110 can comprise an insulating material to prevent electrical conduction between bus bars 130 and other components.

The second spacer 120 is positioned opposite the first spacer 110 such that the bus bars 130 positioned between the first spacer 110 and the second spacer 120. Like the first spacer 110, the second spacer 120 can comprise an insulating material to maintain electrical isolation between conductive components.

The first spacer 110 and second spacer 120 can comprise polymers such as polypropylene, polyamide, or polycarbonate, which offer high dielectric strength and thermal conductivity. The dielectric strength of first spacer 110 and second spacer 120 can be greater than that of air (e.g., greater 3 kV/mm). For example, the dielectric strength of first spacer 110 and second spacer 120 can be in the range of 5-30 kV/mm. In other embodiments, the first spacer 110 and second spacer 120 can comprise ceramic materials, such as alumina or steatite, to provide enhanced heat resistance in high-temperature applications. The size of the first spacer 110 size and second spacer 120 can depend on the design requirements of the conductor assembly 100, and can range from a few millimeters to several centimeters in thickness (e.g., about 0.5 mm, 1 mm, 2 mm, 5 mm, 10 mm, 0.5 cm, 1 cm, 5 cm, etc.), with a length and width sufficient to fully enclose the bus bars 130 positioned between them. The first spacer 110 and second spacer 120 define corresponding openings to accommodate the fasteners 140 that secure the assembly together. In some implementations, the first spacer 110 and the second spacer 120 may be coated with a hydrophobic layer. For example, the hydrophobic coating be a silicone-based or fluoropolymer-based coating, such as polytetrafluoroethylene (PTFE) or a silicone conformal coating. The hydrophobic layer can be configured to repel moisture and prevent water accumulation on the first spacer 110 and the second spacer 120 surfaces, thereby reducing the risk of electrical short circuits or degradation of the insulating properties.

The bus bars 130 are electrically conductive components and are positioned between the first spacer 110 and the second spacer 120. The bus bars 130 can be configured to have high current-carrying capacity. The bus bars 130 can be formed, for example, of copper, copper alloys, or aluminum. The thickness of the bus bars 130 can vary based on the electrical requirements (e.g., operating voltage, operating current, etc.). For example, the thickness of the bus bars 130 can range from about 0.5 mm to 20 mm. Each bus bar 130 may include one or more bends or curves to facilitate the routing of electrical current within the conductor assembly 100. The bus bars 130 extend partially beyond the first spacer 110 and the second spacer 120, allowing for external electrical connections.

The fasteners 140 are components that secure the first spacer 110, the second spacer 120, and the bus bars 130 in place within the conductor assembly 100. Each fastener 140 may pass through corresponding openings in the first spacer 110 and second spacer 120 to maintain alignment and stability of the conductor assembly 100. In some embodiments, the fasteners 140 may be bolts, screws, or other mechanical securing devices, configured to withstand thermal and mechanical stresses within the operating environment of the conductor assembly 100. As shown in FIG. 1, the plurality of fasteners 140 may include one or more central fasteners 140a and one or more peripheral fasteners 140b.

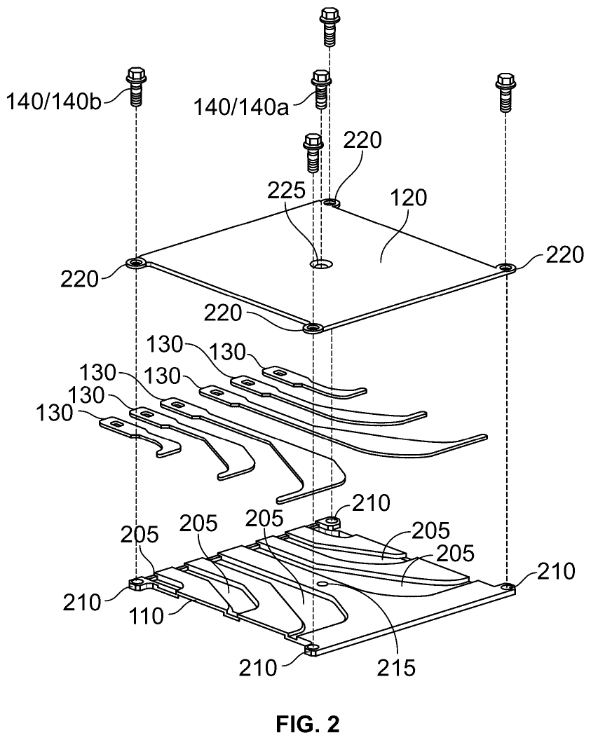

FIG. 2 is an exploded view of the conductor assembly 100 of FIG. 1. Each component of conductor assembly 100 is positioned to demonstrate the placement and relationship between the components of the conductor assembly 100.

In some embodiments, the first spacer 110 and/or second spacer 120 may include positioned cutouts 205 configured to expose portions of the bus bars 130 to facilitate thermal relief. The cutouts 205 allow direct airflow or contact with a coolant over select areas of the bus bars 130, enhancing heat dissipation and helping to maintain optimal operating temperatures within the conductor assembly 100. The structure of the first spacer 110 and second spacer 120 may serve to improve creepage and clearance distances. By modifying the first spacer 110 and/or second spacer 120 structure, the conductor assembly 100 can ensure greater electrical isolation between conductive components. The dielectric strength of the first spacer 110 and second spacer 120 (both greater than 3 kV/mm) can further ensure electrical insulation and reduce the risk of electrical arcing.

In some embodiments, the first spacer 110 may include peripheral first spacer openings 210 and a central first spacer opening 215. The first spacer 110 may include four peripheral first spacer openings 210. The peripheral first spacer openings 210 and the central first spacer opening 215 correspond to locations for the fasteners 140, allowing for alignment during assembly. The peripheral first spacer openings 210 are positioned near the edges or corners of the first spacer 110. The central first spacer opening 215 may be positioned at the center (e.g., geometric center) of the first spacer 110.

In some embodiments, the second spacer 120 may include peripheral second spacer openings 220 and a central second spacer opening 225. The second spacer 120 may include four peripheral second spacer openings 220. The peripheral second spacer openings 220 and the central second spacer opening 212 correspond to locations for the fasteners 140, allowing for alignment with the first spacer 110. The peripheral second spacer openings 220 are positioned near the edges or corners of the second spacer 120. The central second spacer opening 225 may be positioned at the center (e.g., geometric center) of the second spacer 120.

In some embodiments, the peripheral first spacer openings 210, the central first spacer opening 215, the peripheral second spacer openings 220, and the central second spacer opening 225 may be collectively referred to as spacer openings 210, 215, 220, 225. The spacer openings 210, 215, 220, 225 may be reinforced or shaped to hold the fasteners 140 (e.g., central fastener 140a, peripheral fasteners 140b), preventing displacement under mechanical or thermal stresses. The configuration of the spacer openings 210, 215, 220, 225 and the fasteners 140 allows for a compact, layered structure that locates the bus bars 130 between the first spacer 110 and second spacer 120, with extensions of the bus bars 130 protruding from the sides for external electrical connections.

In some embodiments, the central fastener 140a and the peripheral fasteners 140b are of the same size, shape, material, and structure. The conductor assembly 100 may include four peripheral fasteners 140b. The central fastener 140a may pass through the central second spacer opening 225 and the central first spacer opening 215 to couple the second spacer 120 to the first spacer 110. The peripheral fasteners 140b may pass through the peripheral second spacer openings 220 and the peripheral first spacer openings 210 to couple the second spacer 120 to the first spacer 110.

The coupling arrangement of the central fastener 140a and the one or more peripheral fasteners 140b aligns the first spacer 110 and the second spacer 120 with the bus bars 130. In some implementations, the coupling arrangement distributes mechanical loads evenly across the conductor assembly 100, enhancing structural integrity. The spacer openings 210, 215, 220, 225 and fasteners 140 configuration allows for ease of assembly and disassembly, enabling maintenance or replacement of individual components within the conductor assembly 100.

The bus bars 130 are positioned between the first spacer 110 and the second spacer 120, forming an internal conductive layer within the conductor assembly 100. Each bus bar 130 in the plurality of bus bars 130 can have a distinct geometry, allowing for variations in shape, size, and configuration based on the electrical and spatial requirements of the conductor assembly 100. The variations may include different lengths, widths, bends, or curves in individual bus bars 130 to accommodate varying current paths or connection points within the conductor assembly 100. In some embodiments, all bus bars 130 may share a similar geometry for uniformity, while in other embodiments, each bus bar 130 may be custom-shaped to optimize current flow and minimize resistance. The flexibility in geometry allows the conductor assembly 100 to be configured for specific applications and electrical requirements.

In some embodiments, each bus bar 130 of the plurality of bus bars 130 can include a length and a non-uniform width along the length. The non-uniform width can allow for optimized current distribution across different sections of the bus bar, enhancing electrical performance and reducing potential hot spots that could arise from uniform widths. The wider sections of each bus bar 130 can handle higher current densities, while narrower sections can be positioned to allow for better spacing between adjacent bus bars, improving creepage and clearance distances.

In certain embodiments, each bus bar 130 of the plurality of bus bars 130 has a shape that is mirrored by at least one other bus bar 130 within the conductor assembly 100. The mirroring design allows for a symmetrical arrangement of the bus bars 130, which can help balance current distribution and optimize space within the conductor assembly 100. Mirrored shapes can also simplify manufacturing processes by enabling the reuse of identical bus bar designs, which can reduce production costs and ensuring uniformity across components. The symmetry provided by mirrored bus bars 130 can improve mechanical stability and thermal management by distributing stresses and heat more evenly throughout the conductor assembly 100.

In some embodiments, the first spacer 110 is configured to receive the plurality of bus bars 130. The first spacer 110 can include a series of cutouts or recesses designed to accommodate each bus bar 130 geometry. As illustrated in FIG. 2, the cutouts of the first spacer 110 align with the positions of the bus bars 130, allowing them to be securely nested within the first spacer 110. The cutouts of the first spacer 110 can vary in width and depth to match the contours of the bus bars 130. The cutouts of the first spacer 110 can ensure a snug fit that prevents lateral or vertical movement of the bus bars 130.

In some implementations, the cutouts 205 of the first spacer 110 can be grooves. The grooves can be configured to direct the flow of a coolant between the plurality of bus bars 130. The grooves serve as channels for coolant to circulate between individual bus bars 130 and/or through the conductor assembly 100, enhancing thermal management by dissipating heat generated during operation. By directing coolant flow between the bus bars 130, the grooves can maintain a more even temperature distribution across the conductor assembly 100, preventing localized overheating. The grooves can be positioned within the first spacer 110 to ensure that coolant reaches areas of highest thermal demand, effectively removing excess heat from critical points. The grooves can integrate thermal management within the spacer, eliminating the need for additional cooling structures or components.

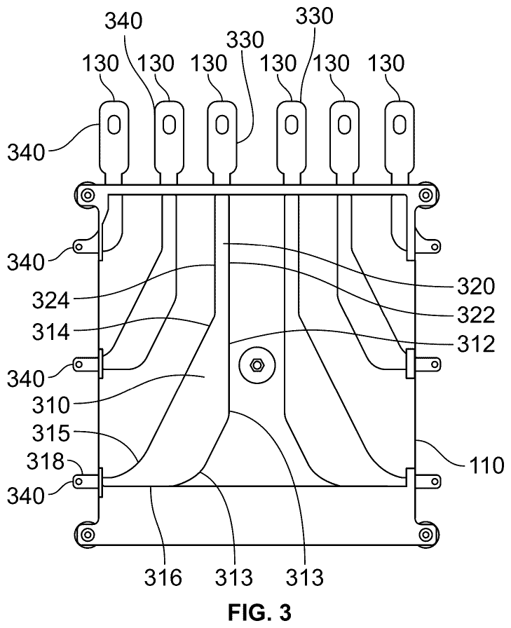

Referring to FIG. 3, in some embodiments, each bus bar 130 includes a leading portion 310, a middle portion 320, and a trailing portion 330. The leading portion 310 extends beyond the first spacer 110 and the second spacer 120 to facilitate external electrical connections, allowing the bus bar 130 to interface with other components or systems outside the conductor assembly 100. The middle portion 320 is positioned between the spacers and provides a conductive path for current flow within the conductor assembly 100. The trailing portion 330 of each bus bar 130 may extend beyond the first spacer 110 and the second spacer 120, creating additional points for electrical connections or grounding, depending on the configuration of the conductor assembly 100. Together, the leading portion 310, the middle portion 320, and the trailing portion 330 define the structure of each bus bar 130, enabling the respective bus bar 130 to meet the electrical and mechanical requirements of the conductor assembly 100.

In some embodiments, the leading portion 310 of at least one bus bar 130 may extend beyond only one of the first spacer 110 and the second spacer 120 (e.g., when the first spacer 110 is smaller in size than the second spacer 120). Similarly, the trailing portion 330 of at least one bus bar 130 may extend beyond only one of the first spacer 110 and the second spacer 120.

In some embodiments, the leading portion 310 of at least one of the plurality of bus bars 130 has a width larger than that of the middle portion 320. The increased width in the leading portion 310 can enhance structural stability and improved current-carrying capacity at the connection point where the bus bar 130 interfaces with external components. Similarly, and in some embodiments, the trailing portion 330 of at least one of the plurality of bus bars 130 has a width larger than that of the middle portion 320.

As shown in FIG. 3, and in some embodiments, the middle portion 320 of each bus bar 130 comprises a middle portion first side 322 and a middle portion second side 324. The middle portion second side 324 can be configured to be substantially parallel to the middle portion first side 322. The parallel configuration between the middle portion first side 322 and the middle portion second side 324 can maintain a uniform width along the middle portion 320 of the bus bar 130, ensuring a stable and uniform conductive path. The parallel configuration between the middle portion first side 322 and the middle portion second side 324 can contribute to effective spacing between adjacent bus bars 130, supporting electrical isolation and enhancing creepage and clearance distances within the conductor assembly 100.

In some embodiments, the leading portion 310 of bus bar 130 adjoins with the middle portion 320 of bus bar 130. The leading portion 310 includes a leading portion first side 312, leading portion second side 314, leading portion third side 316, and leading portion fourth side 318.

In some embodiments, the leading portion first side 312 adjoins the middle portion first side 322. The leading portion first side 312 and the middle portion first side 322 can be configured to form a continuous, straight path along the length of both portions, as shown in FIG. 3. This alignment ensures that the transition between the leading portion first side 312 and the middle portion first side 322 remains linear.

In some embodiments, the leading portion second side 314 is configured to adjoin the middle portion second side 324 and extend at a non-zero angle relative to the middle portion second side 324. By extending at a non-zero angle relative to the middle portion second side 324, the leading portion second side 314 is configured to allow for a gradual widening or narrowing of the bus bar 130. The angled configuration in the leading portion second side 314 allows the width of the leading portion 310 to gradually increase as it extends from the middle portion 320. By extending at a non-zero angle, the leading portion second side 314 creates a tapered or flared shape. The tapered or flared shape at the leading portion 310 can distribute thermal load over a larger area and enhance thermal stability of the conductor assembly 100.

In some embodiments, for at least one of the plurality of bus bars 130, the leading portion first side 312 includes at least one leading portion first side curved portion 313 with a varying radius of curvature along at least a portion of the length of the leading portion first side 312. Similarly, the leading portion second side 314 includes at least one leading portion second side curved portion 315 with a varying radius of curvature along at least a portion of the length of the leading portion second side 314. The leading portion first side curved portion 313 and/or leading portion second side curved portion 315, as shown in FIG. 3, enables a gradual transition in the shape of the bus bar 130, allowing for smooth changes in width or direction without abrupt angles, which can reduce electrical resistance and mechanical stress. The varying radius of curvature of the leading portion first side curved portion 313 and/or leading portion second side curved portion 315 can enhance the mechanical resilience of the bus bar 130 by accommodating bending forces and reducing stress concentrations that could lead to deformation or fatigue over time.

According to an example embodiment, the curvatures within the leading portion first side 312 and/or the leading portion second side 314 may take various forms, incorporating a range of circular or elliptical radii. For example, the curved portions within the leading portion first side 312 and/or the leading portion second side 314 may have a constant radius to create a uniform semi-circular shape. In some examples, the curved portions within the leading portion first side 312 and/or the leading portion second side 314 can be arched shape. The curved portions within the leading portion first side 312 and/or the leading portion second side 314 can include a gradually increasing or decreasing radius. The design variations of the curved portions allow the bus bar 130 to accommodate structural and thermal demands, as a larger radius at certain points can help distribute mechanical stress over a broader area, while a smaller radius may enable compact routing of the bus bar 130 within confined spaces of the conductor assembly 100.

In some embodiments, the leading portion third side 316 adjoins the leading portion first side 312. The leading portion fourth side 318 adjoins the leading portion second side 314. The leading portion fourth side 318 also adjoins the leading portion third side 316. The leading portion fourth side 318 can be configured in various shapes, such as an L-shaped (including a first portion and a second portion extending substantially 90 degrees from an end of the first portion, creating a right-angle bend) or U-shaped form (including a first portion, a second portion, and a third portion, where the second portion curves smoothly between the first and third portions, forming a continuous, rounded base) to accommodate spatial or design requirements within the conductor assembly 100. The variety of possible shapes for the leading portion fourth side 318 allows the leading portion fourth side 318 to adapt to the contours of the conductor assembly 100 or neighboring components, providing flexibility in how the bus bar 130 interfaces with other components.

In some embodiments, at least one extension portion 340 of the bus bar 130 extends beyond the perimeter of the first spacer 110 and second spacer 120, thereby creating a dedicated area for external electrical connections. The extension portion 340 can be a part of the leading portion 310 (e.g., the leading portion fourth side 318) or trailing portion 330. The extension portion 340 can be configured as a connection point for other electrical components, allowing the conductor assembly 100 to interface with external circuits or devices. By extending beyond the first spacer 110 and second spacer 120 boundaries, the extension portion 340 provides an accessible and reliable contact point that maintains electrical isolation from the rest of the assembly, reducing the risk of short circuits. The design of the extension portion 340 can include holes or tabs, enabling secure attachment through connectors, fasteners, or soldering points.

In certain embodiments, the conductor assembly 100 can be configured to operate at voltage levels ranging from about 1000 to 1200 V. The conductor assembly 100 can be configured to manage thermal losses in the range of tens to hundreds of watts, For example, the conductor assembly 100 can manage thermal losses of 5 W, 10 W, 20 W, 50 W, 100 W, 200 W, 500 W, 750 W.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “generally,” “substantially,” “similarly,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

What is claimed is:

1. A conductor assembly, comprising:
a first spacer;
a second spacer;
a plurality of bus bars positioned between the first spacer and the second spacer, the first spacer shaped to receive the plurality of bus bars; and
a plurality of fasteners coupling the first spacer and the second spacer.

2. The conductor assembly of claim 1, wherein the first spacer and second spacer each comprise an electrically insulating material.

3. The conductor assembly of claim 2, wherein the electrically insulating material has a dielectric strength greater than 3 kV/mm.

4. The conductor assembly of claim 1, wherein the first spacer includes at least one groove therein, the at least one groove configured to direct flow of coolant between the plurality of bus bars.

5. The conductor assembly of claim 1, the first spacer and the second spacer each define a plurality of openings, each fastener of the plurality of fasteners passing through a corresponding opening of the plurality of openings on each of the first spacer and the second spacer so as to couple the first spacer and the second spacer.

6. The conductor assembly of claim 1, wherein each of the plurality of bus bars have a length and a non-uniform width along the length.

7. The conductor assembly of claim 6, wherein each of the plurality of bus bars comprises a leading portion, a middle portion, and a trailing portion, the leading portion of at least one of the plurality of bus bars having a width larger than a width of the middle portion thereof.

8. The conductor assembly of claim 7, wherein the trailing portion of at least one of the plurality of bus bars has a width larger than a width of the middle portion thereof.

9. The conductor assembly of claim 7, wherein, for at least one of the plurality of bus bars, the middle portion comprises:
a middle portion first side; and
a middle portion second side, the middle portion second side substantially parallel to the middle portion first side.

10. The conductor assembly of claim 9, wherein, for at least one of the plurality of bus bars, the leading portion comprises:
a leading portion first side, the leading portion first side adjoining the middle portion first side;
a leading portion second side, the leading portion second side adjoining the middle portion second side, the leading portion second side extending at a non-zero angle relative to the middle portion second side;
a leading portion third side, the leading portion third side adjoining the leading portion first side; and
a leading portion fourth side, the leading portion fourth side adjoining the leading portion second side.

11. The conductor assembly of claim 10, wherein, for at least one of the plurality of bus bars, the leading portion first side includes at least one curved portion with a varying radius of curvature along at least a portion of the leading portion first side.

12. The conductor assembly of claim 11, wherein, for at least one of the plurality of bus bars, the leading portion second side having at least one curved portion with a varying a radius of curvature along at least a portion of a length of the leading portion second side.

13. The conductor assembly of claim 1, wherein each of the plurality of bus bars comprises:
at least one extension portion extending beyond the perimeter of the spacers, the at least one extension portion providing electrical connection points for other electrical components.

14. The conductor assembly of claim 1, wherein each bus bar of the plurality of bus bars has a shape mirrored by at least one other bus bar of the plurality of bus bars.

15. The conductor assembly of claim 1, wherein each of the plurality of bus bars have a length and a substantially uniform width along the length.

16. The conductor assembly of claim 1, wherein the first spacer and the second spacer are coated with a hydrophobic layer.

17. The conductor assembly of claim 1, wherein the plurality of bus bars include at least one curve or bend therein.
